(19) United States
(12) Patent Application Publication
(10) Pub. No.: US 2024/0340029 A1
(43) Pub. Date: Oct. 10, 2024

(54) METHOD AND APPARATUS FOR TRANSMITTING A SIGNAL.

(71) Applicant: Anthony Peter Hulbert, Southampton (GB)

(72) Inventor: Anthony Peter Hulbert, Southampton (GB)

(21) Appl. No.: 10/167,643

(22) Filed: Jun. 11, 2002

(30) Foreign Application Priority Data
Jun. 19, 2001 (GB) 0115019.2

(51) Int. Cl. H04B 1/02

(52) U.S. Cl. CPC H04B 1/02

(57) ABSTRACT

There is described a method of transmitting an ultra wideband (UWB) signal. The method comprises, inputting an information signal, generating a pseudo random time hopping code; generating a pulse inversion code and using the pseudo random time hopping code, pulse inversion code and information signal to generate the UWB signal. The time hopping code is used to modulate pulses of the signal in a pseudo random manner in order to channelise the signal whilst the pulse inversion code is used to provide additional modulation to pulses of the signal in order to further randomise the signal.

This invention relates to a method and apparatus for transmitting a signal. In particular, but not exclusively, this invention relates to a method and apparatus for transmitting an ultra wideband (UWB) radio signal.

Ultra wideband radio, also known as impulse radio, is a technology in which communication is achieved by the transmission and reception of discrete baseband pulses each pulse having a very short duration, typically a nanosecond or less. The form of a typical UWB pulse 1 is shown in FIG. 1. The pulses generally have a centre frequency of between 50 MHz and 10 GHz, are very wideband (100+% of the centre frequency) in bandwidth and are transmitted with a duty cycle of the order of 1%.

There are several known methods for providing data modulation in impulse communication systems. Two of the more useful methods are pulse position modulation and pulse inversion modulation. In pulse position modulation, the position in time of the pulses in the pulse train is modulated in dependence upon a data signal. For example, to represent the data value ‘1’ a pulse may be shifted forward in time an amount δ from its notional regular position in the pulse train, and to represent the value ‘−1’ a pulse may be delayed in time by an amount δ from its notional regular position in the pulse train.

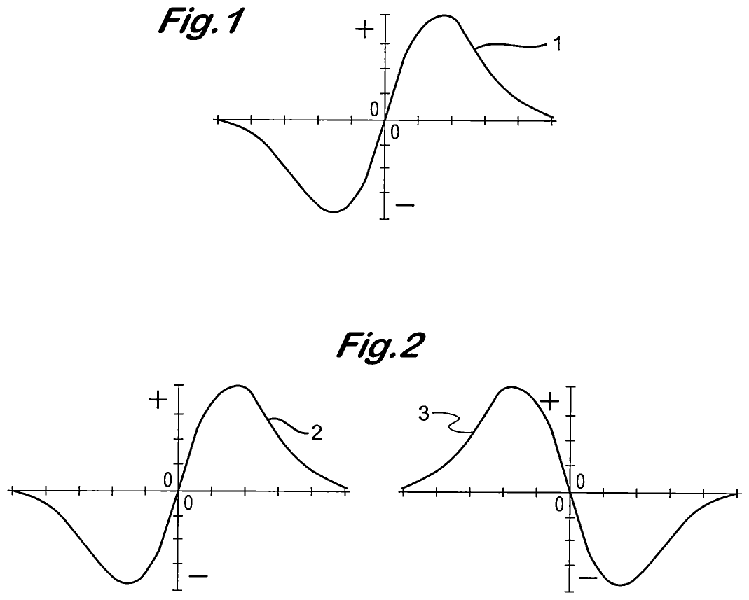

In pulse inversion modulation, a pulse may be transmitted ‘uninverted’ to represent a data value ‘1’ and ‘inverted’ to represent a data value ‘−1’ (or vice versa). For example, as is illustrated in FIG. 2, the pulse 2 in which the amplitude of the first half of the pulse is positive and in which the amplitude of the second half of the pulse is negative may be used to represent the data value ‘1’, and the pulse 3, in which the amplitude of the first half of the pulse is negative and in which the amplitude of the second half of the pulse is positive, may be used to represent the data value ‘−1’. Clearly, which of the pulses 2 or 3 is considered be inverted and which is considered to be non-inverted is a matter of definition only.

If transmitted on a regular basis an impulse signal would generate a pulse train which could interfere with the operation of any other radio system having a bandwidth that encompassed a harmonic of the pulse repetition frequency. To mitigate this effect it is known in the art to apply at the transmitter a pseudo random time hopping code to the pulse train.

The time hopping code introduces a pseudo random variation to the time at which each pulse is transmitted within the nominal available period for transmitting the pulse. This modifies the signal resulting in a spectrum having more lines at closer spacing but of lower power. The line spacing is related to the length of the time hopping code. Multiple access (ie a plurality of users operating in the system bandwidth) can be achieved by allocating a different time hopping code to each user, to create distinct communication channels. Interference between channels will take place only when the time of a received pulse from an interfering transmitter coincides with the time of the received pulse from a wanted transmitter. In theory, by using completely orthogonal time hopping codes such interference could be avoided all together. However, completely orthogonal codes are unachievable in practice, and so codes with good cross correlation properties over a wide range of time offsets are used instead.

Additionally, a further form of spread spectrum may be employed if the transmitter associates a number N (N>1) of pulses with every data bit instead of just a single pulse. This increases the processing gain of the system and helps further reduce interference. The nominal timing of each pulse is determined by the time hopping code used, with additional timing adjustments determined by the modulating scheme if pulse position modulation is employed.

In UWB receivers, correlators are used to correlate the received signal with a locally generated version of the time hopping code used to encode the transmitted signal. The local code is synchronised with the code in the received signal and the signals output from the correlator are accumulated over the period of each bit to produce a de-spread data signal. Typically 100 pulses or more may be used to represent a bit. Correlators suitable for de-modulating pulse position modulated or pulse inversion modulated UWB signals are well known in the art.

Impulse radio is a technology of growing importance that has a wide variety of applications, including personal communications systems, in-building communications systems and wireless local area networks.

Despite the use of time hopping codes to provide multiple access for different user's of a UWB communications system, inter channel interference still does occur. It is therefore desirable to provide an improved UWB communications system in which inter channel interference is further reduced.

According to the invention there is provided, a method of transmitting a communication signal, which signal comprises a series of pulses, the method comprising: inputting an information signal; generating a pseudo random code; generating a secondary code; using the pseudo random code, secondary code and information signal to generate the communication signal, wherein the pseudo random code is used to modulate pulses of the signal in a pseudo random manner in order to channelise the signal, and wherein the secondary code is used to provide additional modulation to pulses of the signal in order to further randomise the signal; and transmitting the communication signal.

According to the invention there is also provided an apparatus for transmitting communication signal, which signal comprises a series of pulses, the apparatus comprising: input means for inputting an information signal; a first generator for generating a pseudo random code; a second generator for generating a secondary code; means for using the pseudo random code, secondary code and information signal to generate the communication signal, wherein the means uses the pseudo random code to modulate pulses of the UWB signal in a pseudo random manner in order to channelise the signal, and wherein the means uses the secondary code to provide additional modulation to pulses of the signal in order to further randomise the signal; and transmitter means for transmitting the communication signal.

According to the invention there is also provided a system for transmitting an ultra wideband signal, the signal comprising a plurality of pulses, each of which may be transmitted either inverted or non-inverted, wherein the inversion state of the transmitted pulses is modulated on a pulse by pulse basis in dependence upon a generated code.

Embodiments of the present invention will now be described with reference to the accompanying drawings, in which;

FIG. 1 shows the form of an exemplary UWB pulse;

FIG. 2 illustrates pulse inversion modulation;

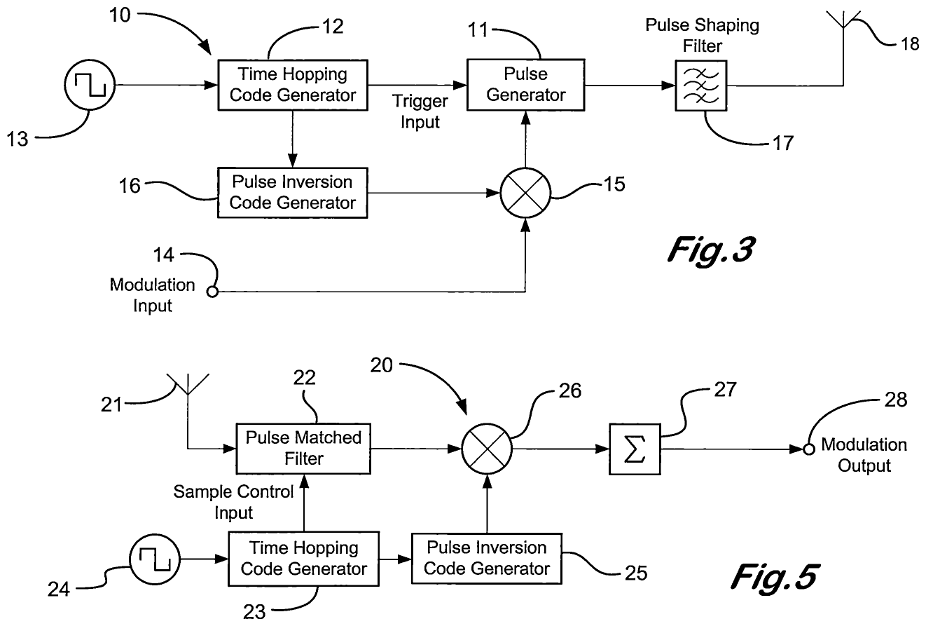

FIG. 3 illustrates a block diagram of a transmitter;

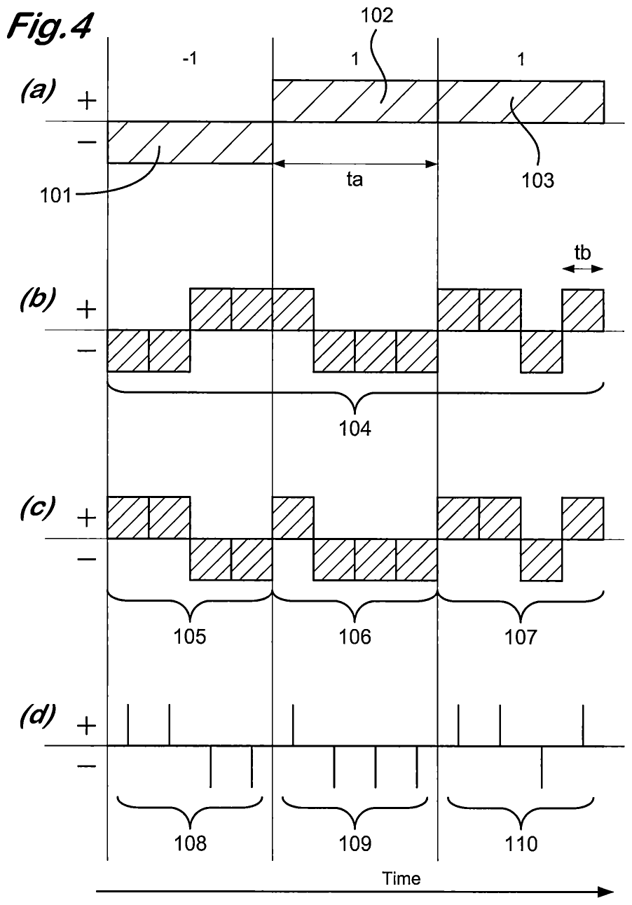

FIG. 4 illustrates a schematic diagram of signals used to generate a UWB signal.

FIG. 5 illustrates a block diagram of a receiver;

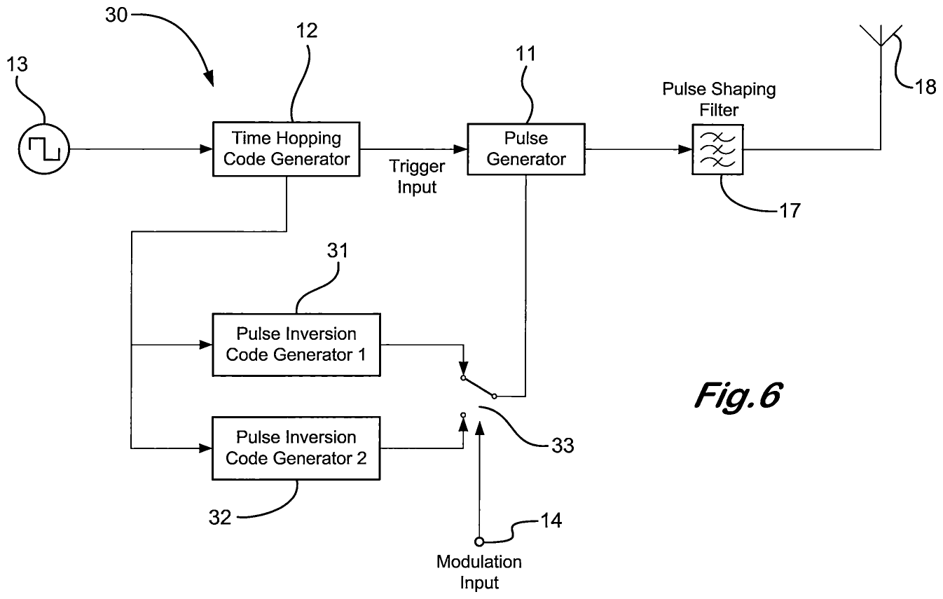

FIG. 6 illustrates a block diagram of another transmitter;

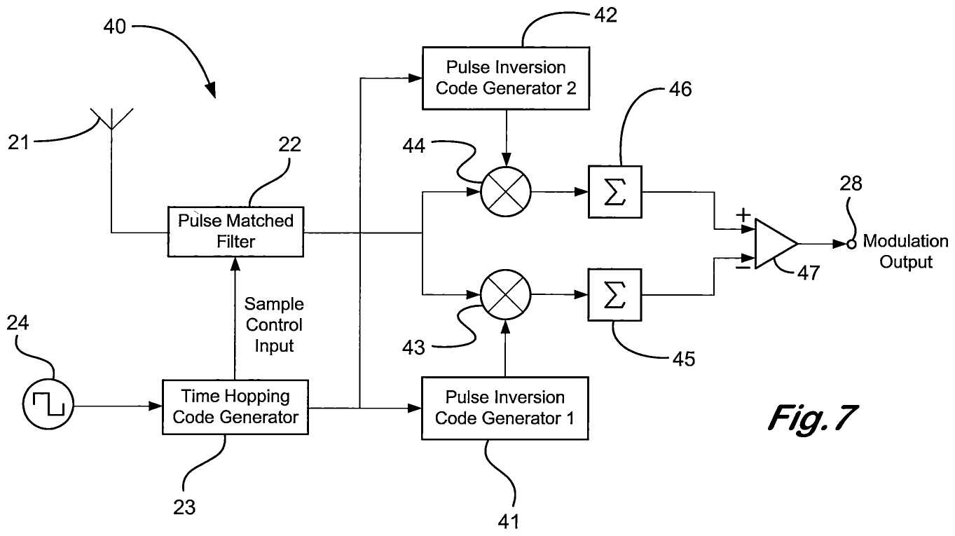

FIG. 7 illustrates a block diagram of another receiver;

Referring to FIG. 3 there is illustrated a block diagram of an UWB transmitter 10 embodying the present invention. In this embodiment the transmitter 10 generates a UWB signal in which pulse inversion modulation is used to modulate the pulses of the UWB signal in accordance with an information signal. A pseudo random time hopping code is used to modulate the timing of the pulses in the signal in order to channelise the signal and advantageously, a secondary spreading code is used to apply additional modulation at the pulse level, to further randomise the UWB signal.

The transmitter 10 comprises a pulse generator 11 for generating the pulses of an UWB signal. Pulse generators suitable for use in UWB transmitters are well known to those skilled in the art, and may for example make use of avalanche transistors to generate the UWB signal.

The transmitter 10 further comprises a time hopping code generator 12 which operates in a conventional manner, under the control of an oscillator 13, to apply a pseudo random time hopping code to the pulses of the signal transmitted by the transmitter 10 in order to channelise the signal. As will be appreciated by those skilled in the art, each time a signal is to be transmitted, the time hopping code generator 12 selects a time hopping code from a large number of pre-programmed substantially mutually orthogonal pseudo random time hopping codes available to the generator for application to the signal. To this end, the time hopping code generator 12 produces trigger outputs that feed a trigger input of the pulse generator 11 at pseudo random intervals in dependence upon the code used. For example, the oscillator frequency may be 1 GHz, outputting a regular rising step voltage to a control input of the time hopping code generator 12 every nanosecond. The time hopping code generator 12 may be arranged to produce a trigger output once within every 32 ns period, with the timing of the output within each 32 ns period varying pseudo-randomly according to the code used. This can be achieved by arranging for the time hopping code generator 12 to produce, in dependence upon the selected code, a unique 5 bit number every 32 ns period. This number then determines the number of input oscillator 13 pulses for which the time hopping code generator 12 must wait before outputting a trigger output in any given 32 ns period.

The transmitter 10 further comprises a modulation input 14, for inputting a data signal to the transmitter 10. In this example, the modulation input 14 may comprise any form of binary or bipolar generator for generating current or voltage values of +1 or−1 units, to define a binary sequence representing voice, image or any other type of data to be transmitted.

In previous transmitters, the modulation input has been directly connected to a control input of the pulse generator. In such transmitters, the pulse generator produces a narrow pulse for every trigger input supplied by the time hopping code generator and depending upon the polarity of the data signal supplied to the control input of the generator, each generated pulse may or may not be inverted. The pulses are thereby modulated in dependence upon the data signal.

To increase processing gain, a large number of successive pulses (typically 100 or more) would be used to represent each bit of transmitted information. So for example, to transmit a bit of value +1, the modulation input would be held constant at +1 units at the control input of the pulse generator, long enough for say 100 trigger inputs to be received from the time hopping code generator, causing the pulse generator to generate 100 sequential pulses, all with the same modulation or inversion state, for example non-inverted.

In such a scheme, to transmit a bit of value −1, the modulation input would be held constant at −1 units at the control input of the pulse generator, long enough for say 100 trigger inputs to be received from the time hopping code generator, thus causing the pulse generator to generate 100 sequential pulses, all of which are inverted.

In the new transmitter 10, rather than the data signal from the modulation input 14 being supplied to the control input of the pulse generator 11, the data signal is instead multiplied at a multiplier 15 with a secondary spreading code generated by a secondary code generator 16, to generate an inversion control signal which is fed to the control input of the pulse generator 11. The secondary code generator 16 is itself a binary or bipolar generator which outputs a code of successive elements each of which can take the value of +1 or −1 units. The secondary code generator 16 is arranged to output one code element every period within which the time hopping code generator 12 generates a trigger input. Thus the inversion control signal comprises a succession of elements, one for each secondary code element, and the binary value of each element depending upon the values of the code element and data signal that were multiplied together to generate it.

The pulse generator 11 produces a narrow pulse for every trigger input from the time hopping code generator 12, and depending upon the polarity of the inversion control input, the resultant pulse may or may not be inverted. Each generated pulse is fed through a pulse shaping filter 17 to an antenna 18 for onward transmission.

Advantageously, in the signal transmitted by the transmitter 10, unlike in previous UWB systems using pulse inversion modulation, the inversion state of the pulses which together represent a particular bit need not be all the same. Instead, the inversion state of the pulses can vary on a pulse by pulse basis, in dependence upon the secondary code thereby further randomising the signal.

This is illustrated in FIG. 4 which shows a schematic diagram of signals used in the transmitter to generate a UWB signal. For simplicity of discussion, each transmitted bit is to be represented by four pulses only and the effects of the time hopping code are ignored.

A portion of a data input signal (a) represents three consecutive bits 101 to 103 value −1 1 1 respectively. To represent a bit of value 1, the amplitude of the data signal is positive over the period of the bit tₐ. To represent a bit of value −1, the amplitude of the data signal is negative over the period tₐ of the bit. A portion of a secondary code (b) comprises 12 code elements 104 of varying sign. The period t_{b} of each code element is ¼ of the bit period tₐ. The data signal (a) is multiplied with the secondary code (b) to generate pulse control signal (c). In the pulse control signal (c) the three groups 105 to 107 of four code elements represent the bits −1 1 1 respectively. Compared to the data signal input (a) the sign of some of the code elements in the signal (c) have been inverted by the secondary code (b). The pulse control signal (c) feeds the pulse generator control input as described above and for each trigger input from the time hopping code generator the pulse generator produces a pulse. Each one of the code elements of the control signal (c) determines the inversion state of a generated pulse, resulting in UWB signal (d) in which three groups 108 to 110 of four pulses represents the data bits −1 1 1 respectively.

The secondary code generator stores a large number of secondary codes, and each time a communication link is opened between the transmitter and a receiver in a UWB communications, one of the codes is selected for use. Advantageously, a different secondary code together with a different time hopping code may be used in each link operating in the communications system, thereby producing a form of “double randomisation” in the transmitted signal of each link. Preferably, the secondary codes available for use in the system are relatively orthogonal to each other. Using a different secondary code and a different time hopping code in each link increases the immunity of each link to multiple access interference because the randomness or noise like characteristics of the interference is increased, thereby improving the tolerance of wanted signals to the interference.

Referring now to FIG. 5, there is shown a block diagram of an UWB receiver 20 which is complementary to the transmitter 10 described with respect to FIG. 3.

The receiver 20 comprises an antenna 21 for receiving an UWB signal and feeding the received signal to an input of a pulse matched filter 22. The receiver 20 further comprises a time hopping code generator 23 for controlling the operation of the filter 22 and an oscillator 24 for clocking the time hopping code generator 23.

In operation, the time hopping code generator 23 generates a local version of the time hopping code that was applied to the transmitted signal. The local version of the time hopping code is supplied to a control input of the pulse matched filter 22 and is synchronised with the time hopping code of the received signal. In order to synchronise the time hopping code generator in the receiver with that in the transmitter, the receiver is provided with a synchronisation sub system (not shown). Such synchronisation systems are well known to those skilled in the art and may employ for example standard code searching techniques and make use of unmodulated pilot signals to synchronise the time hopping codes.

In response to the local version of the time hopping code supplied from the generator 23, the pulse matched filter 22 samples the received signal at the peak values of the received pulses. The output corresponding to any given pulse is held constant in the filter output until the next pulse is sampled. The filter thus correlates the locally generated time hopping code with the received signal.

The signal output from the filter 22 is still encoded with the secondary code applied to the originally transmitted signal. In order for the data signal to be recovered at the receiver, this secondary code must be removed from the signal output from the filter 22. To this end the receiver 20 is provided with its own secondary code generator 25 which is clocked by the time hopping code generator 23 to generate a local version of the secondary code applied to the originally transmitted signal and which is synchronised with the secondary code of the received signal.

The secondary code generated by the secondary code generator 25 and the received signal output from the filter 22 are fed to respective inputs of a multiplier 26 which multiplies the two signals together to generate at its output a received signal from which the secondary code has been removed.

The output of the multiplier 26 is accumulated over the period of each bit in an accumulator 27 to de-spread the received signal and to produce a soft decision variable the sign of which is indicative of the likely value of the corresponding data bit generated at the transmitter. The decision variables output from the accumulator 27 at the modulation output 28 form the data signal output from the receiver. As an example consider the reception at the receiver 20 of a UWB signal generated according to the scheme described above with respect to FIG. 4. Assuming error free transmission and reception, of the portion of the UWB signal (d), the signal output from the pulse matched filter 22 will have the same form as the inversion control signal (c). Multiplying a locally generated version of the code (b) with the signal output from the filter 22, results in a signal of the same form as the data signal (a), which is then accumulated over the period of each bit to generate decision variables.

FIG. 6 illustrates a UWB transmitter 30 that makes use of code shift keying to generate an UWB signal. In FIG. 6 components corresponding to components already described with respect to FIG. 3 have been given like reference numerals and their function is as described with reference to FIG. 3. The transmitter 30 is provided with first 31 and second 32 secondary code generators of the type described with reference to FIG. 3, each of which is clocked by the time hopping code generator 12. The output of each of the secondary code generators is connectable via a switch 33 to the control input of the pulse generator 11.

The switch 31 is connected to and controlled by the modulation input 14.

In operation, each of the first and second generators 31 and 32 generates a different secondary spreading code, and the modulation state of the modulation input 14 selects which of these codes is to be applied to the control input of the pulse generator 11. The modulation input can take one of the two values, +1 or −1 units. Every time the modulation state is a particular one of these values, for example, +1, the switch 33 is arranged so as to connect the output of a particular one of the two generators 31 and 32, for example, the first generator 31 to the control input of the pulse generator 11, so that a predetermined number of sequential code elements output by that code generator are used to generate pulses which represent a +1 bit. Likewise, each time the modulation state 14 is the other value, for example, −1 units, the switch 33 is arranged to connect the output of the other generator, in this example, the second generator 32, to the control input of the pulse generator 11, so that a predetermined number of sequential code elements output by that code generator are used to generate pulses which represent a-1 bit.

Thus, in such a transmission scheme in which N, for example 100, consecutive pulses are used to represent each bit of information, to transmit a bit of value +1, the modulation input connects the output of the first generator 31 to the input of the pulse generator 11 for 100 successive elements of the first code to be applied to the pulse generator 11. Likewise, to transmit a bit of value −1, the modulation input 14 connects the output of the second generator 32 to be connected to the control input of the pulse generator, for 100 successive elements of the second code to applied to the pulse generator 11.

Referring now to FIG. 7, there is shown a block diagram of an UWB receiver 40 which is complementary to the transmitter 30 described with respect to FIG. 6. In FIG. 7, components corresponding to components already described with respect to the receiver 20 described with reference to FIG. 4 have been given like reference numerals and their function is as described with reference to FIG. 4.

The receiver 40 comprises first 41 and second 42 secondary spreading code generators, each of which, in use is clocked by the time hopping code generator 23, and respectively generate local versions of the first and second codes applied to the transmitted signal. The output of the first generator 41 is connected to the input of a first multiplier 43 and the output of the second generator 42 is connected to an input of a second multiplier 44. The first 43 and second 44 multipliers each have another input connected to the output of the pulse matched filter 22. The output of each of the multipliers 43 and 44 is connected to the input of a respective one of two accumulators 45 and 46, the outputs of which feed a subtractor 47.

In operation, each consecutive sample output from the pulse matched filter 22 is fed to the first multiplier 43 and also to the second multiplier 44. Each plurality of samples output from the filter 22 which together represent a bit, will be encoded with either the first code or the second code, depending upon the value of the bit they represent. At the first multiplier 43 each input sample is multiplied by a respective element of the first code. Likewise, at the second multiplier 44 each input signal sample is multiplied by a respective element of the second code. Assuming error free transmission and reception, over the period of a bit, the signals output from whichever of the multipliers 43 and 44 has applied the correct code for that bit, will have had the secondary code removed by the multiplication. Hence, those signals will all be of the same sign. Over the period of the same bit, the signals output from whichever of the multipliers 43 and 44 applies the in-correct code, will not have had the secondary code removed by the multiplication and the signs of those signals will thus vary.

Over the period of each bit, the signals output from the first 43 and second 44 multipliers are accumulated in the first 45 and second 46 accumulators respectively, which then each output an accumulated signal to the subtractor 47. The magnitude of the signal output from whichever of the accummulators has accumulated correctly de-coded signals will be larger then the magnitude of the signal output from the other accumulator. Thus each decision variable can be formed by the subtractor 47 taking the difference between the outputs of the two accumulators.

For example, if at the transmitter 30 the first secondary code is used to transmit each bit of value 1 and the secondary code is used to transmit each bit of value−1, then each time a bit of value 1 is received at the receiver 40, the output of the first accumulator 45 will be of greater magnitude than the output of the second accumulator 46. Likewise, each time a bit of value −1 is received at the receiver 40, the output of the second accumulator 46 will be of greater magnitude than the output of the first accumulator 45. It will be appreciated by those skilled in the art, that in practice, error free communication is unachievable, and so each decision variable is indicative only of the likely value of the received bit.

It will be appreciated that any of the UWB transmitters or receivers described in either of our co-pending UK patent applications 0108826.9 or 0111254.9 may be readily adapted to transmit or receive an UWB signal generated using a pulse inversion code as described hereinabove.

Having thus described the present invention by reference to preferred embodiments it is to be well understood the embodiments in question are exemplary only and that modifications and variations such as will occur to those possessed of appropriate knowledge and skills may be made without departure from the scope of the invention as set forth in the appended claims.

1. A method of transmitting a communication signal, which communication signal comprises a series of pulses, the method comprising:
inputting an information signal;
generating a pseudo random code;
generating a secondary code;
using the pseudo random code, secondary code and information signal to generate the communication signal, wherein the pseudo random code is used to modulate pulses of the communication signal in a pseudo random manner in order to channelise the signal, and wherein the secondary code is used to provide additional modulation to pulses of the communication signal in order to further randomise the signal; and
transmitting the communication signal.

2. A method according to claim 1 wherein the communication signal is an ultra wideband signal.

3. A method according to claim 1, wherein the pseudo-random code is a time hopping code, which modulates the timing of pulses in the communication signal on a pseudo-random basis.

4. A method according to claim 1, wherein the secondary code is a pulse inversion code, which modulates the inversion state of pulses in the communication signal.

5. A method according to claim 1, wherein the communication signal is information modulated using pulse inversion modulation.

6. A method according to claim 1, wherein the communication signal is a spread spectrum signal in which a bit of information is represented by a plurality of pulses, and wherein each of the pulses has a modulation state which may vary on a pulse by pulse basis in dependence upon the secondary code.

7. A method according to claim 1, wherein the secondary code and the information signal are multiplied together to generate a modulation control signal, and wherein the modulation control signal and the pseudo random code are used to generate the communication signal.

8. A method according to claim 1, wherein the secondary code comprises a first secondary code and a second secondary code, wherein each of the first and second secondary codes is used to modulate groups of pulses in the communication signal, and wherein the information signal is used to select which secondary code is used to modulate any given group of pulses.

9. A method according to claim 8 wherein each group of pulses represents an information bit, which bit may take either a first value or a second value, and wherein the first secondary code is used to modulate each group of pulses which represents a bit having the first value and the second secondary code is used to modulate each group of pulse which represent a bit having the second value.

10. A method according to claim 9, wherein each of the pulses in a group of pulses has a modulation state which may vary on a pulse by pulse basis in dependence upon the code used to modulate the group.

11. An apparatus for transmitting a communication signal, which signal comprises a series of pulses, the apparatus comprising:
input means for inputting an information signal;
a first generator for generating a pseudo random code;
a second generator for generating a secondary code;
means for using the pseudo random code, secondary code and information signal to generate the communication signal, wherein the means uses the pseudo random code to modulate pulses of the communication signal in a pseudo random manner in order to channelise the communication signal, and wherein the means uses the secondary code to provide additional modulation to pulses of the communication signal in order to further randomise the signal; and
transmitter means for transmitting the communication signal.

12. An apparatus according to claim 11 wherein the communication signal is an ultra wideband signal.

13. An apparatus according to claim 10, wherein the pseudo random code is a time hopping code, which modulates the timing of pulses in the communication signal on a pseudo-random basis.

14. An apparatus according to claim 11, wherein the secondary code is a pulse inversion code, which modulates the inversion state of pulses in the communication signal.

15. An apparatus according to claim 11, wherein the communication signal is information modulated using pulse inversion modulation.

16. An apparatus according to claim 11, wherein the communication signal is a spread spectrum signal in which a bit of information is represented by a plurality of pulses, and wherein each of the pulses has a modulation state which may vary on a pulse by pulse basis in dependence upon the secondary code.

17. An apparatus according to claim 11, wherein the secondary code and the information signal are multiplied together to generate a modulation control signal, and wherein the modulation control signal and the pseudo random code are used to generate the communication signal.

18. An apparatus according to claim 11, wherein the secondary code comprises a first secondary code and a second secondary code, wherein each of the first and second secondary codes is used to modulate groups of pulses in the communication signal, and wherein the information signal is used to select which secondary code is used to modulate any given group of pulses.

19. An apparatus according to claim 18 wherein each group of pulses represents an information bit, which bit may take either a first value or a second value, and wherein the first secondary code is used to modulate each group of pulses which represents a bit having the first value and the second secondary code is used to modulate each group of pulse which represent a bit having the second value.

20. An apparatus according to claim 18, wherein each of the pulses in a group of pulses has a modulation state which may vary on a pulse by pulse basis in dependence upon the code used to modulate the group.

21. A method of de-spreading a communication signal transmitted in accordance with the method of claim 1, which communication signal is a spread spectrum signal, the method comprising;
receiving the communication signal;
generating a local version of the pseudo random code;
correlating the local version of the pseudo random code with the received communication signal to output a correlated signal;
generating a local version of the secondary code;
multiplying the local version of the secondary code with the correlated signal to output a de-coded spread signal;
de-spreading the spread signal to output an information signal.

22. A method according to claim 21 wherein the communication signal is an ultra wideband signal.

23. An apparatus for de-spreading a communication signal transmitted by the apparatus according to claim 11, which communication signal is a spread spectrum signal, the apparatus comprising;
means for receiving the communication signal;
a first generator for generating a local version of the pseudo random code;
a correlator for correlating the local version of the pseudo random code with the received communication signal to output a correlated signal;
a second generator for generating a local version of the secondary code;
a multiplier for multiplying the local version of the secondary code with the correlated signal to output a de-coded spread signal;
de-spreading means for de-spreading the spread signal to output an information signal.

24. An apparatus according to claim 23 wherein the communication signal is an ultra wideband signal.

25. (canceled)
